(19) United States
(12) Patent Application Publication
(10) Pub. No.: US 2008/0212525 A1
(43) Pub. Date: Sep. 4, 2008

(54) USING DEVICE PROFILE TO DETERMINE THE MOST SUITABLE RESOURCE RESERVATION FOR AN APPLICATION

(76) Inventors: Janne Tervonen, Espoo (FI); Wei Cui, Espoo (FI)

Correspondence Address: MORGAN & FINNEGAN, LLP, 3 World Financial Center, New York, NY, 10281-2101, US

(21) Appl. No.: 11/681,404

(22) Filed: Mar. 2, 2007

(51) Int. Cl. H04Q 7/00

(52) U.S. Cl. 370/329

(57) ABSTRACT

A system, method, apparatus, and computer program product are disclosed for introducing a specific Device Profile into a wireless protocol that defines some basics of how the WiMedia UWB radio platform can be used to transmit audiovisual data. Further, embodiments enable the Device Profile information and other significant parameters, such as, for example application QoS requirements and current radio conditions, to be used to determine optimal radio resource allocation for WiMedia UWB communication in order to ensure safe data transfer, while taking into account possible power saving requirements for the data transfer.

### FIELD OF THE INVENTION

The present invention relates to the field of wireless short-range communication, and more particularly to how devices can transfer audiovisual information and determine optimal radio resource allocation for the data transfer over a short-range communication link, taking into account the application Quality of Service (QoS) requirements, Device Profile information, and the current radio conditions (including other reservations).

### BACKGROUND OF THE INVENTION

Short-range wireless proximity networks typically involve devices that have a communications range of one hundred meters or less. To provide communications over long distances, these proximity networks often interface with other networks. For example, short-range networks may interface with cellular networks, wireline telecommunications networks, and the Internet.

High rate physical layer (PHY) techniques for short-range proximity networks are quickly emerging. One such technique involves frequency hopping applications of orthogonal frequency division multiplexing (OFDM). This technique involves the transmission of OFDM symbols at various frequencies according to pre-defined codes, such as Time Frequency Codes (TFCs). Time Frequency Codes can be used to spread interleaved information bits across a larger frequency band.

The WiMedia Alliance has developed an OFDM physical layer. This physical layer is described in WiMedia Alliance MultiBand OFDM Physical Layer Specification, Release 1.1, Jan. 14, 2005 (also referred to herein as the WiMedia PHY). This document is incorporated herein by reference in its entirety.

The WiMedia Medium Access Control (MAC) group is developing a MAC layer that will be used with an OFDM physical layer, such as the WiMedia PHY. A current version of this MAC is described in O'Conor, Jay; Brown, Ron (ed.), Distributed Medium Access Control (MAC) for Wireless Networks, WiMedia Technical Specification, Release 1.0, Dec. 8, 2005 (also referred to herein as the WiMedia MAC Specification v. 1.0). This document is incorporated herein by reference in its entirety.

This MAC layer involves a group (referred to as a beacon group) of wireless communications devices that are capable of communicating with each other. The timing of beacon groups is based on a repeating pattern of “superframe” periods, during which the devices may be allocated communications resources. These communications resources may be in the form of one or more time slots, referred to as medium access slots (MASs).

MAC layers govern the exchange among devices of transmissions called frames. A MAC frame may have various portions. Examples of such portions include frame headers and frame bodies. A frame body includes a payload containing data associated with higher protocol layers, such as user applications. Examples of such user applications include web browsers, e-mail applications, messaging applications, and the like.

In addition, MAC layers govern the allocation of resources. For instance, each device requires an allocated portion of the available communication bandwidth to transmit frames. The WiMedia MAC provides for the allocation of resources to be performed through communications referred to as beacons. Beacons are transmissions that devices use to convey non-payload information. Each device in a beacon group is assigned a portion of bandwidth to transmit beacons.

Such transmissions allow the WiMedia MAC to operate according to a distributed control approach, in which multiple devices share MAC layer responsibilities. Accordingly, the WiMedia MAC Specification v. 1.0 provides various channel access mechanisms that allow devices to allocate portions of the transmission medium for communications traffic. In WiMedia MAC, two channel access mechanisms are defined: Prioritized Contention Access (PCA) and Distributed Reservation Protocol (DRP). PCA is WLAN-like contention-based access, where each device equally contends for the channel access. DRP is a reservation-based access mechanism that gives a device an opportunity to reserve certain amount of UWB channel time for its own exclusive use. DRP reservations are unidirectional between one transmitter and one or more receivers. Only the owner (the transmitter) can access the channel during the DRP reservation. The intended recipients are active (radio on) during the DRP reservation. DRP reservations consist of one or more Medium Access Slots (MAS); one MAS lasts 256 us, in a superframe there are 256 MASs altogether. DRP reservations are very suitable for video streaming applications, for example.

Basically, when a WiMedia UWB device is active, it is required to broadcast its own beacon to the other devices and to listen to the beacons from its neighboring devices. Thus, the device needs to be awake during a beacon period. This means that the most power-efficient location of a reservation is immediately before the next beacon period or immediately after the previous beacon period. This can be seen with reference to FIG. 2A, which shows superframe formats employed in shared transmission media, including beacon and data transfer periods.

The WiMedia UWB MAC and PHY specification were published in ECMA-386 specification: ECMA-386, High Rate Ultra Wideband PHY and MAC Standard, ECMA Standard, 1st Edition, December 2005. It defines a set of rules (in Annex B) to control making DRP reservations. This set of rules is called MAS allocation policies. The allocation policies define two types of reservations: “safe” and “unsafe”. A “safe” reservation is such that the other devices cannot request the owner of the “safe” reservation to relocate or release the reservation. However, other devices may request the owner of an “unsafe” reservation to modify the reservation to be “safe”. The owner of the reservation has 4 superframes time to re-organize the reservation (after receiving Relinquish Request message) so that it doesn't violate the safeness rules anymore. Thus, the owner is required to make the reservation “safe” or, if this is not possible (e.g., due to other reservations), the “unsafe” reservation will be released.

Currently, these allocation policy rules do not favor power-efficient reservations. Instead, MAS allocation policy forces “safe” reservations to be allocated evenly across the whole superframe. If the reservation is split evenly across the whole superframe, both the transmitter and the receiver devices need to stay active for the duration of the superframe and the devices cannot enter sleep mode to save any energy during a superframe.

Currently, the maximum throughput of the WiMedia radio platform is 480 Mbps. Depending on the transmission power and bit rate used, the practical maximum range of a UWB radio is 10 meters. In the future UWB releases, it is planned to increase the maximum throughput up to 2 Gbps.

High quality wireless video steaming is not possible to date, due to its high bandwidth requirements and high power consumption. With Ultra Wide Band (UWB), a low power, high speed radio technology standard developed in WiMedia, wireless video streaming becomes practical. UWB transmission at 480 Mbps with transmission mask of −41 dbm/MHz, has the potential to support an uncompressed or lossless compressed video screen size up to Super Video Graphics Array (SVGA) display mode (800×600×24 bits) with 30 frames/second rate. This would be an extraordinary achievement for wireless video applications.

The current problem with a wireless audiovisual transmission is that the transmitter doesn't have knowledge of the receiver device's characteristics or capacities before it sends the data through the radio link. Thus, the visual data and audio data received at the receiver may have their rendered images and sounds reduced in resolution or entirely precluded from presentation.

Wireless video streaming is not widely considered as a practical application due to its high bandwidth requirement. But, with the development of high speed radio technologies, such as WLAN, UWB, 3GPP LTE, HSPA, etc., plus the advances in audio/video compression technology, wireless video streaming becomes a distinct possibility for mobile wireless communication. However, the radio link is not as reliable as is a wired connection, which raises the question of how the video quality can be guaranteed.

Thus, the prior art is confronted with problems of how wireless devices can transfer audiovisual information and determine optimal radio resource allocation for the data transfer over an UWB link, taking into account the application Quality of Service (QoS) requirements, Device Profile information, and the current radio conditions (including other reservations).

### SUMMARY OF THE INVENTION

These and other problems are solved by the embodiments of the invention, which enable wireless devices to transfer audiovisual information and determine optimal radio resource allocation for the data transfer over an UWB link, taking into account the application QoS requirements, Device Profile information, and the current radio conditions (including other reservations).

A system, method, apparatus, and computer program product are disclosed for a wireless communications network. One aspect of the method includes the steps of:
storing device profile information in a wireless receiver device in the network, the device profile information describing characteristics of the wireless receiver device's audiovisual reception capabilities and output capabilities;
sending by a wireless transmitter device in the network to the wireless receiver device, a request for the device profile information;
sending by the wireless receiver device, the device profile information to the wireless transmitter device, in response to the request; and
sending by the wireless transmitter device, reservation information in response to the device profile information, for reserving a portion of available communication bandwidth to send the audiovisual data to the wireless receiver device.

The reservation information can be further in response to QoS requirement information describing QoS parameters for an audiovisual application and to current radio conditions, including reservations by other wireless devices of available communication bandwidth.

The device profile information can include power supply status information for the wireless device, the reservation information establishing an optimal radio resource allocation to minimize power consumption by the wireless device in response to the power supply status information.

In embodiments, the reservation information reserves a portion of available communication bandwidth of an Ultra Wide Band (UWB) link to receive the audiovisual data. The reservation information reserves a portion of available medium access slots (MAS) of a WiMedia Ultra Wide Band (UWB) link to receive the audiovisual data. The reservation information ensures safe data transfer, while taking into account possible power saving requirements for receiving the audiovisual data.

The embodiments of the invention introduce a specific Device Profile into a wireless protocol that defines some basics of how the WiMedia UWB radio platform can be used to transmit audiovisual data. Further, embodiments of the invention enable the Device Profile information and other significant parameters, such as, for example application QoS requirements and current radio conditions, to be used to determine optimal radio resource allocation for WiMedia UWB communication in order to ensure safe data transfer, while taking into account possible power saving requirements for the data transfer.

In general, the wireless protocol defines how WiMedia UWB radio platform can be used to transmit both compressed and non-compressed video data. One of the main ideas of the wireless protocol is to enable power efficient usage of the radio channel, e.g. by dynamically releasing radio resources when they are not needed. The wireless protocol supports two usage models:

1. Internal Model: the internal audio/video interface of a device is replaced with UWB radio and the wireless Protocol.

2. External Model: UWB radio and the wireless protocol is used to transport audio/video signal between two distinct devices.

Logically, the wireless protocol provides control and audio/video data transport services. The wireless protocol offers the following high-level control functionalities:
Establish and maintain control channel between the peer devices.
Make an appropriate reservation on UWB radio channel for the audio/video data transfer, based on the Device Profile.
Monitor radio link quality and take corrective actions if the quality deteriorates.

When the wireless protocol is used as a transport protocol, the wireless protocol also provides the basic transport layer functionality:
The wireless protocol is responsible for framing the audio and/or video data packets to be forwarded to MAC layer.
Provide timing and synchronization information for video data packets to be transferred over UWB radio interface.

Optionally, the wireless protocol may support a mode where the wireless protocol is used only as a control protocol. This requires some other transport protocol for the actual audio/video data transfer. For example, an RTP-UDP-based protocol stack can be used for that purpose.

In this manner, the resulting embodiments of the invention solve problems of how devices can transfer audiovisual information and determine optimal radio resource allocation for the data transfer over an UWB link, taking into account the application Quality of Service (QoS) requirements, Device Profile information, and the current radio conditions (including other reservations).

### BRIEF DESCRIPTION OF THE DRAWINGS

In the drawings, like reference numbers generally indicate identical, functionally similar, and/or structurally similar elements. The drawing in which an element first appears is indicated by the leftmost digit(s) in the reference number. The present invention will be described with reference to the accompanying drawings, wherein:

FIG. 1 is a schematic diagram of the protocol layers of a wireless transmitter and receiver, including the wireless protocol, according to embodiments of the present invention;

FIGS. 2A and 2B are diagrams of superframe formats employed in shared transmission media;

FIGS. 3 and 4 are exemplary flow charts of the resource allocation algorithm and optimization algorithm of the wireless protocol, according to embodiments of the present invention;

FIG. 5 illustrates a superframe with two similar DRP reservations, wherein the left side allows sleeping during the superframe, according to embodiments of the present invention

FIG. 6 illustrates an exemplary superframe in which a DRP reservation has “unsafe” and “safe” parts, according to embodiments of the present invention;

FIG. 7 illustrates an exemplary superframe in which there are two safe reservations for one application, according to embodiments of the present invention;

FIG. 8 illustrates a superframe example of a 10 Mbps reservation for a Constant Bit Rate (CBR) video stream, according to embodiments of the present invention;

FIG. 9 illustrates a superframe example of a 10 Mbps reservation for a Variable Bit Rate (VBR) video stream, according to embodiments of the present invention;

FIG. 10 illustrates a superframe in which there are two 10 Mbps reservations for a video stream for 400 Mbps with some reserve MASs, according to embodiments of the present invention;

FIG. 11 illustrates a superframe example of two 10 Mbps reservations for a video conferencing application for 400 Mbps with some reserve MASs, according to embodiments of the present invention;

FIG. 12 illustrates a superframe example of a reservation for Video Graphics Array (VGA)-sized un-compressed video transfer (˜300 Mbps), according to embodiments of the present invention;

FIG. 13 illustrates the General Architecture of a Transmitter and a Receiver, according to embodiments of the present invention; and

FIG. 14 is a more detailed diagram of the Receiver of FIG. 13, according to embodiments of the present invention.

FIG. 15 shows an example hardware implementation of both the transmitter 100 and the receiver 100′, according to embodiments of the present invention.

### DETAILED DESCRIPTION OF THE PREFERRED EMBODIMENTS

### I. Introduction

The following abbreviations and definitions will be helpful in describing embodiments of the present invention.

A. Abbreviations
3GPP LTE 3rd Generation Partnership Project Long Term Evolution
ASIE Application Specific Information Element (WiMedia MAC)
AV Audiovisual
DRP Distributed Reservation Protocol (WiMedia MAC)
DVD Digital Versatile Disc
DVI Digital Visual Interface
HDMI High-Definition Multimedia Interface
HSPA High Speed Packet Access
IE Information Element (WiMedia MAC, beacon)
JPEG Joint Photographic Experts Group
MAC Medium Access Control
MAS Medium Access Slot (WiMedia MAC)
MPEG Moving Picture Experts Group
MSC Message Sequence Chart
OFDM Orthogonal Frequency-Division Multiplexing
PCA Prioritized Contention Access (WiMedia MAC)
PDU Protocol Data Unit
PHY Physical Layer
RTP Real-Time Transport Protocol
SAP Service Access Point
SCART Syndicat des Constructeurs d'Appareils Radiorecepteurs et Televiseurs
UWB Ultra WideBand
WiNet WiMedia Networking Protocol
WLAN Wireless Local Area Network

B. Definitions
Beacon period: On the WiMedia MAC, every superframe starts with a beacon period. Each active device broadcasts its own beacon information to the others. All the active devices are required to send their own beacon information and listen to the other devices' beacons. Since the devices need to be active anyway, the most power-efficient period of time to transmit any data on UWB radio link is just right after the beacon period (i.e. in the very beginning of the data period).
Compressed video: Video compression is used to reduce the required bandwidth/size of video signal/recording. Currently, MPEG-2 is the most widely used compression mechanism.
DRP: Distributed Reservation Protocol (DRP) is the other access mechanism provided by WiMedia MAC. DRP is a reservation-based access mechanism that gives a device a possibility to reserve certain amount of UWB channel time for its own exclusive use.
DRP reservation: Reservation of UWB channel time is made by using DRP protocol. DRP reservations are unidirectional between one transmitter and one or more receivers. Only the owner (the transmitter) can access the channel during the DRP reservation. The Wireless protocol uses DRP reservations for both control and video data transfer. During the DRP reservation, the intended recipients will be active (radio on). In the wireless protocol, DRP reservations are used for the actual AV data transfer.
MAS: On the WiMedia MAC, the superframe is divided into 256 MASs. Thus, each MAS lasts 256 us. MAS is the smallest addressable reservation unit with DRP reservations.
Non-compressed video: In the wireless protocol, non-compressed video signal refers to a “raw” Red, Green, Blue (RGB) (analog) signal. The color of each pixel on the screen is represented with components of three primary colors: red, green and blue. Depending on the color depth, there can be different amounts of bits reserved for representing RGB components.
PCA: Prioritized Contention Access (PCA) is the other access mechanism WiMedia MAC provides. PCA is a contention-based access mechanism, where no guarantees for granted channel time for a device can be given. In general, PCA is a copy of WLAN contention-based channel access mechanism. When using PCA, the receiver can define when it is active on a superframe, and the transmitter then sends its data during this period. With this method, devices effectively need to be active only during the actual data transmission. In the wireless protocol, PCA is normally used only for control messages.
PCA reservation: The WiMedia MAC provides also a DRP reservation of type PCA. PCA reservation does not have the owner; all the devices can access the channel during the PCA reservation using the PCA rules. The benefit of using PCA reservation is to guarantee at least some PCA time against possible numerous other (type of) DRP reservations. For battery-powered devices, the wireless protocol may use PCA reservation for control channel.
Superframe: This is a periodic, basic unit of time on the WiMedia MAC layer. One superframe lasts 65,536 microseconds, and it is divided into beacon and data transfer periods.
Control Channel: This is a logical channel for transporting control messages. Both transmitter and receiver will have their own control channels to transmit control messages between the devices. Control Channel can be dedicated (stand-alone) or associated with a video data channel. In practice, Control Channel can be realized either with “pure” DRP reservations or PCA reservations.
Wireless device: This is a device that implements the wireless protocol.
Audio/Video Data Channel: This is a logical channel for transporting video data. Video Data Channel is always realized with a DRP reservation.

### II. The Wireless Protocol

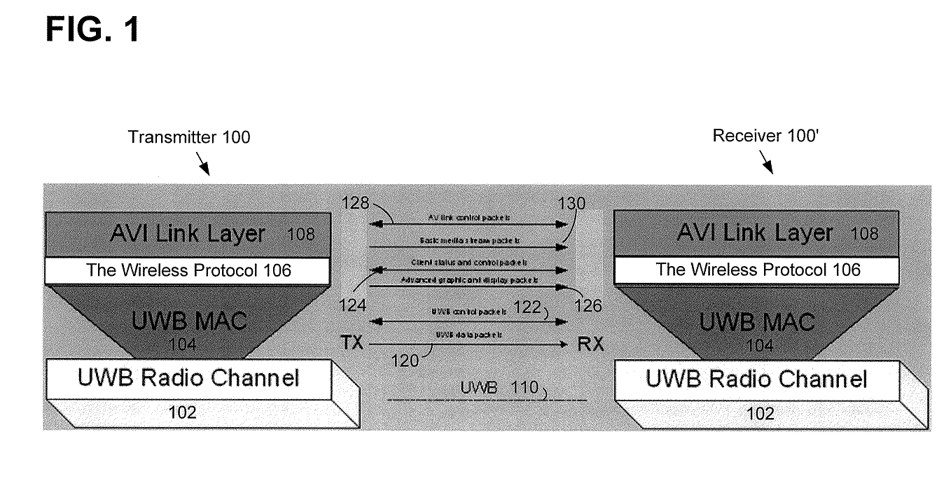

FIG. 1 is a schematic diagram of the protocol layers of a wireless transmitter 100 and receiver 100′, including the wireless protocol 106, according to embodiments of the present invention. The wireless protocol 106 enables audiovisual (AV) devices interoperate with each other in the way that the characteristics of the receiver 100′ are known to the transmitter 100 before any data packets are sent. The wireless part of the wireless protocol is based on WiMedia UWB MAC protocol. The diagram schematically depicts two communication nodes, a transmitter TX 100 and a receiver RX 100′. Each node has the same protocol stack, beginning with the UWB Radio Channel physical layer 102. Above that in ascending order are the UWB MAC layer 104, the wireless protocol layer 106, and the Audiovisual Link layer (AVI) 108. UWB radio packets 110 are exchanged over the UWB Radio Channel physical layer 102. UWB data packets 120 and control packets 122 are managed by the UWB MAC layer 104. Client status and control packets 124 and advanced graphic and display packets 126 are managed by the wireless protocol layer 106. AV link control packets 128 and basic media stream packets 130 are managed by the AVI layer 108.

### III. Superframe

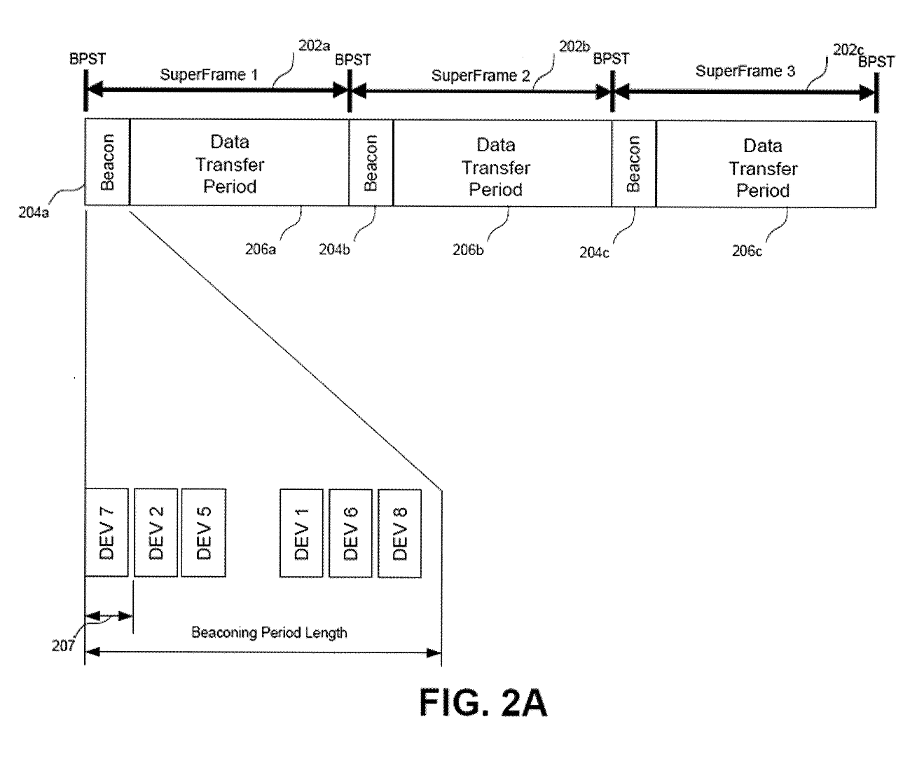

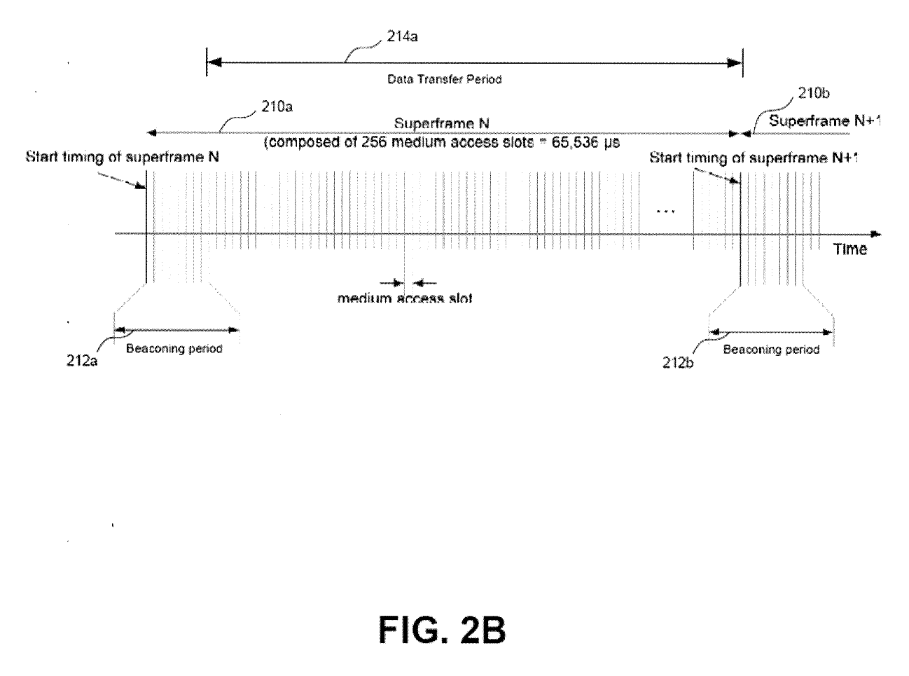

Wireless network transmissions, such as beacons and data communications may be based on a repeating time pattern, such as a superframe. An exemplary superframe format is shown in FIG. 2A. In particular, FIG. 2A shows a frame format having superframes 202a, 202b, and 202c.

Each superframe 202 includes a beacon period 204 and a data transfer period 206. Beacon periods 204 convey transmissions from each of the active devices in the beaconing group. Accordingly, each beacon period 204 includes multiple beacon slots 207. Slots 207 each correspond to a particular device in the network. The devices employing beacon slots 207 are referred to as a beaconing group. During these slots, the corresponding device may transmit various overhead or networking information. For WiMedia networks, such information may be in predetermined forms called Information Elements (IEs).

For instance, such information may be used to set resource allocations and to communicate management information for the beaconing group. In addition, according to the present invention, data transfer periods 206 may be used to transmit information regarding services and features (e.g., information services, applications, games, topologies, rates, security features, etc.) of devices within the beaconing group. The transmission of such information in beacon periods 204 may be in response to requests from other devices.

Data transfer period 206 is used for devices to communicate data according to various transmission schemes. These schemes may include, for example, frequency hopping techniques that employ OFDM and/or time frequency codes (TFCs). For instance, data transfer periods 206 may support data communications and, additionally, devices may use data transfer periods to transmit control information, such as request messages to other devices. The current WiMedia MAC provides the command and control frames for the transfer of such information. To facilitate the transmission of traffic, each device may be allocated one or more particular time slots within each data transfer period 206. In the context of the WiMedia MAC, these time slots are referred to as medium access slots (MASs).

A MAS is a period of time within data transfer period 206 in which two or more devices can exchange data (i.e., communicate). According to the WiMedia MAC, MASs may be allocated by a distributed protocol, called the distributed reservation protocol (DRP). DRP protects the MASs from contention access by devices acknowledging the reservation. Alternatively, the WiMedia MAC provides for resource allocation according to a prioritized contention access (PCA) protocol. Unlike DRP, PCA isn't constrained to reserving one or more entire MASs. Instead, PCA can be used to allocate any part of the superframe that is not reserved for beaconing or DRP reservations.

FIG. 2B is a diagram of a frame format designated by the WiMedia MAC Specification v. 1.0. Like the frame format of FIG. 2A, the WiMedia frame format has successive superframes 210. As shown in FIG. 2B, the current WiMedia superframe includes 256 MASs and has duration of 65,536 microseconds. Within each WiMedia superframe 210, a first set of MAS(s) is designated as a beaconing period 212. The number of MASs in this period is flexible, so it may dynamically change. The remaining portion (i.e., the non-beaconing period portion) of the WiMedia superframe 210 is designated as a data transfer period 214.

### IV. Device Profile

Device Profile describes the characteristics of the wireless device in terms of its audio and video output (presentation) capabilities and its transmission/reception capabilities. Each wireless device will store its own Device Profile in memory. When requested (with the message DEVICE PROFILE REQUEST), a wireless device will provide its Device Profile to the requester (with the message DEVICE PROFILE RESPONSE). Any wireless device may request the Device Profile of its peer wireless device any time after the initial device discovery. However, according to various embodiments of the present invention, before initiating audio/video data transfer, at least the intended transmitter will have requested (and received) the Device Profile of the intended audio/video stream receiver.

An example definition for Device Profile is given below in Table 1. The purpose of the various fields is described below.

TABLE 1
An example definition of Device Profile.

| Bytes: 1 | 1 | 4 | 1 | N | 4 | 1 | 4 |
|---|---|---|---|---|---|---|---|
| General Info | Device Info | Device | Length of | Device | Available | Battery | Native |
| | | Identification | Device | Description | buffer space | status | Resolution |
| | | | Description | | | | |
| | | | (in bytes) | | | | |

| 1 | 4 | . . . | 4 | 1 | 1 | 1 | 1 | 4 |
|---|---|---|---|---|---|---|---|---|
| Number of | Supported | . . . | Supported | Frame Rate | Color Depth | Audio Type | Compression | Supported |
| Supported | Resolution 1 | | Resolution N | | | | Support | Transport |
| Resolutions | | | | | | | | Protocols |

The example in Table 1 is not a comprehensive list of all possible parameters in the Device Profile, but it provides an example of the range of characteristics that can be described.

The purposes of the various example fields of the Device Profile shown in the above table are described in greater detail as follows. The definitions of various device profile parameters are examples only.

General Info—1 byte: This field of the Device Profile shown in the above table identifies the receiver as possessing the wireless protocol capability and identifies the wireless protocol version number.

Device info—1 byte: This field of the Device Profile shown in the above table identifies the receiver as either an Internal or External device and specifies other capabilities of the receiver.

An internal device can be a mobile phone display and speaker, which uses a special control mechanism to control and display the image. An external device can be a TV, an independent display such as a computer display, a car display, etc.

The Device Info field also specifies whether the receiver has a buffered display. A buffered display has buffering memory for at least one frame, e.g. RGB information for each pixel on the screen. Non-buffered displays are only capable of displaying the current incoming video signal.

The Device Info field also specifies whether the receiver has a zoomability capability. If a display supports zoomability, the display can independently resize the received video feed to match, e.g. its native resolution. Zooming (or scaling) requires a certain amount of processing power in the receiver.

The Device Info field also specifies whether the receiver has a Black and White or a Color display, whether it is Battery-powered or externally powered as power supply status information, whether it has support for double line reception, and whether it has support for double frame reception.

Device Identification—4 bytes: This field of the Device Profile shown in the above table identifies the receiver's Device ID number.

Length of Device Description—1 byte: This field of the Device Profile shown in the above table defines the length (in bytes) of the following Device Description field (one byte corresponds one ASCII letter).

Device Description—N bytes: This field of the Device Profile shown in the above table is the receiver's Device Description in ASCII letters, which can be presented in a human-readable, free text format.

Available Buffer Space—4 bytes: This field of the Device Profile shown in the above table indicates currently available buffer space in kilobytes.

Battery Status—1 byte: This field of the Device Profile shown in the above table indicates the current battery level, e.g. in percentage and indicates also the power supply status for the device.

Native Resolution—4 bytes: This field of the Device Profile shown in the above table specifies the native resolution of the receiver's display as the number of horizontal pixels and vertical pixels.

Number of supported resolutions—1 byte: This field of the Device Profile shown in the above table specifies the number of following fields that respectively specify different supported resolutions in the receiver's display. If the value for number of supported resolutions field is zero and the display has indicated it has a zoomability feature, the receiving display can accept any resolution up to native resolution.

Supported Resolutions—4 bytes×N, OPTIONAL: Each of these fields of the Device Profile shown in the above table specifies a different supported resolution in the receiver's display as the number of horizontal pixels and vertical pixels.

Frame Rate—1 byte: This field of the Device Profile shown in the above table defines the possible frame rates (in frames/second) the device is capable of supporting.

Color Depth—1 byte: This field of the Device Profile shown in the above table specifies the color depth of the receiver's display. It should be further noted that especially the size of this Color Depth field may vary depending on the embodiment.

Audio Type—1 byte: This field of the Device Profile shown in the above table specifies the audio type of the receiver's sound system as having no audio support, one channel, two channels (stereo), three channels, five channels, six channels, seven channels, eight channels, and/or other audio configurations.

Compression Support—1 byte: This field of the Device Profile shown in the above table specifies the compression support for the receiver's video system as having, for example, MPEG-2 support, MPEG-3 support, MPEG-4 support, Motion JPEG support, Proprietary Lossy Compression support, Proprietary Lossless Compression support, Support for variable compression rate, and/or Support for switching between compressed and non-compressed modes on the fly.

Supported Transport Protocols—4 bytes: This field of the Device Profile shown in the above table specifies the supported transport protocols for the receiver as RTP support, WiNet support, and/or support for the wireless protocol as transport protocol.

Various Device Profile fields can be used when optimizing a reservation to be as power-efficient as possible.

### V. Resource Allocation Algorithm

Resource Allocation Algorithm uses the Device Profile in deciding the most suitable resource allocation. In accordance with embodiments of the invention, the resource allocation algorithm finds the best radio resource allocation for an application, taking into account the application QoS parameters, Device Profile, and the current radio conditions (including other reservations). Generally, the most important QoS parameters for a video stream are bit rate, delay and jitter requirements. Currently, the WiMedia MAC supports the following bit rates (in Mbps): 53.3, 80, 106.7, 160, 200, 320, 400 and 480. The resource allocation algorithm estimates the radio link conditions and especially the maximum achievable bit rate.

In accordance with embodiments of the invention, the resource allocation algorithm finds a reservation that fulfills the application QoS requirements and is compliant with the Device Profile of the receiver. Further, the reservation is a best fit to the current radio conditions (the highest achievable, probable bit rate) and other pre-existing reservations. The reservation is selected to be as power-efficient as possible.

In accordance with embodiments of the invention, the resource allocation algorithm uses the wireless protocol to establish and maintain a control channel between the peer devices. It makes an appropriate reservation on a UWB radio channel for the audio/video data transfer, based on the receiver's Device Profile.

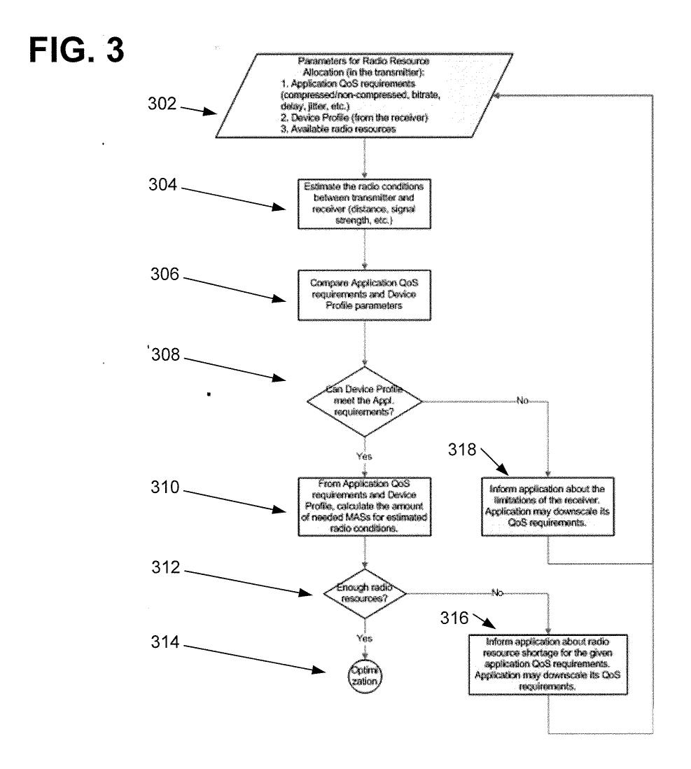

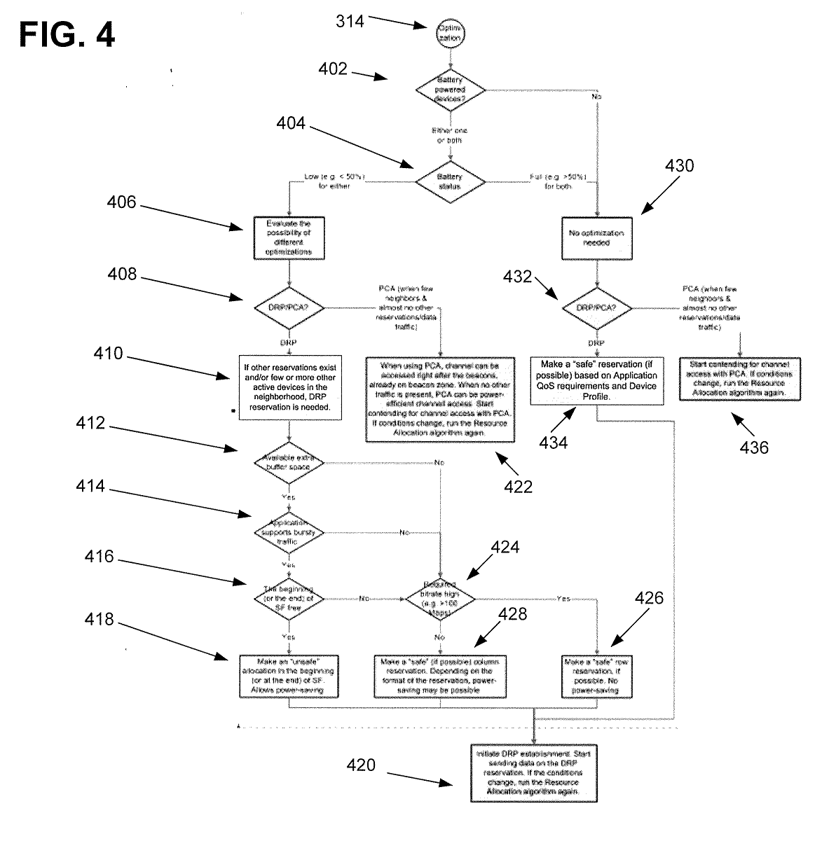

FIG. 3 and FIG. 4 present a general level flow chart of the resource allocation algorithm, according to embodiments of the present invention. The steps of the Radio Resource Allocation flow diagram of FIG. 3 are as follows.

Step 302: Determine Parameters for Radio Resource Allocation in the Transmitter: [1] QoS Requirements of the application at the transmitter, [2] Device Profile received from the Receiver, [3] Available Radio Resources. The application's QoS requirements are typically set forth in a table of QoS parameters, which are based, for example, on the application's required transmission bit rate and its sensitivity to delay and jitter. The receiver's Device Profile will have been previously requested and received at the transmitter. The available radio resources are the available medium access slots (MASs) in the superframe, as observed at the transmitter and, optionally, as observed at the receiver and communicated to the transmitter.

Step 304: Estimate the radio conditions between transmitter and receiver (based on distance, received signal strength, etc.).

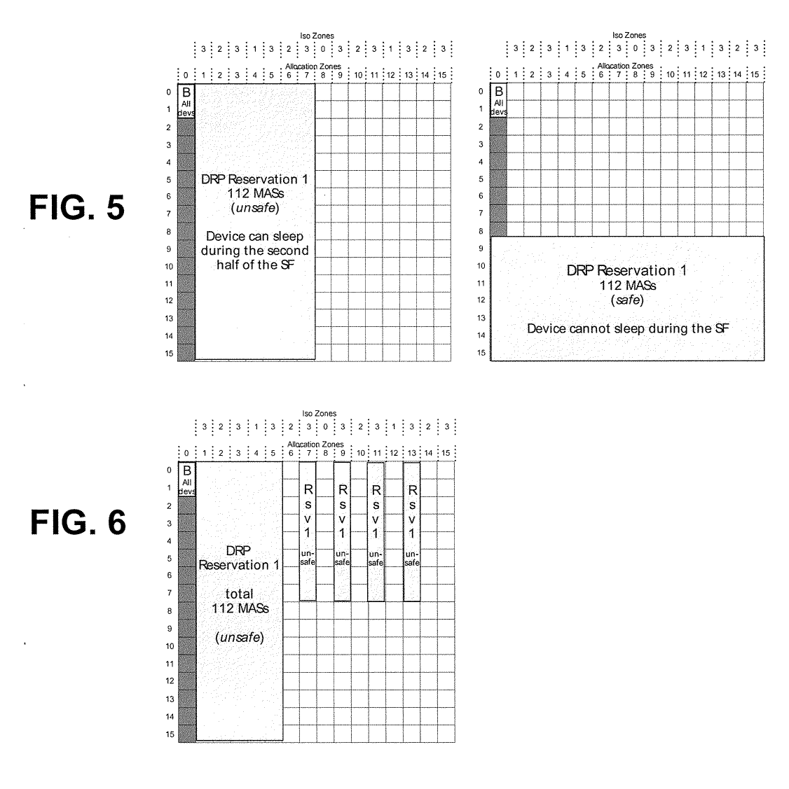

Step 306: Compare application QoS requirements and Device Profile parameters. Some general guidelines for comparing the application QoS requirements and the Device Profile parameters are given below in discussing the example allocations shown in FIGS. 5-12.

Step 308: Decision: Can Device Profile meet application requirements?

Step 310: If Yes: Then From Application QoS requirements and Device Profile, calculate the amount of MASs needed for estimated radio conditions. Some general guidelines for calculating the quantity of MASs needed for estimated radio conditions, application QoS requirements, and the Device Profile parameters are given below in discussing the example allocations shown in FIGS. 5-12.

Step 312: Decision: Enough Radio Resources?

Step 314: If Yes: Then Optimization (Go to FIG. 4.)

Step 316: If No: Then Inform Application about radio resource shortage for the given application QoS requirements. Application may downscale its QoS requirements. Return to Step 302.

Step 318: From Decision Step 308: If No: Then Inform Application about the limitations of the receiver. Application may downscale its QoS requirements. Return to Step 302.

The Optimization flow diagram of FIG. 4 flows from the Radio Resource Allocation flow diagram of FIG. 3 at Step 314. The steps of the Optimization flow diagram of FIG. 4 are as follows.

Step 314: Optimization.

Step 402: Decision: Battery powered devices?

Step 404: If Either one or both: Then Decision: Battery Status?

Step 406: If Low (e.g. <50%) for either: Then evaluate the possibility of different optimizations.

Step 408: Decision: DRP or PCA?

Step 410: If DRP: Then If other reservations exist and/or few or more other active devices in the neighborhood, DRP reservation is needed.

Step 412: Decision: Available extra buffer space?

Step 414: If Yes: Then Decision: Does Application support bursty traffic?

Step 416: If Yes: Then is the beginning (or the end) of the superframe free?

Step 418: If Yes: Then make an “unsafe” allocation in the beginning (or the end) of superframe. Allows power saving. In this case, FIGS. 5 (left side), 6 and 10 (left side) illustrate some examples of possible allocations.

Step 420: Initiate DRP establishment. Start sending data on the DRP reservation. If the conditions change, run the Resource Allocation Algorithm again (Step 302 of FIG. 3).

Step 422: From Decision Step 408: If PCA (when few neighbors and almost no other reservations/data traffic): Then when using PCA, channel can be accessed right after the beacons, already on beacon zone. When no other traffic is present, PCA can be power-efficient channel access. Start contending for channel access with PCA. If conditions change, run the Resource Allocation Algorithm again (Step 302 of FIG. 3).

Step 424: From Decision Step 412: If No: Then is required bit rate high (e.g. >100 Mbps)?

Step 426: If Yes: Then make a “safe” row reservation, if possible. No power-saving. Go to Step 420. In this case, FIGS. 5 (right side), 11 and 12 illustrate some examples of possible allocations.

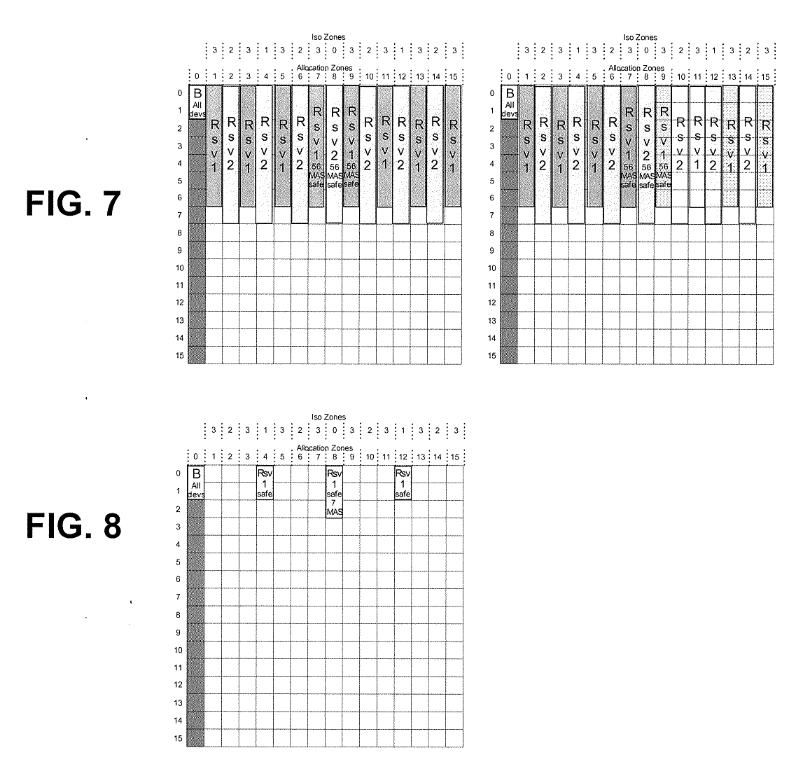

Step 428: If No: Then make a “safe” (if possible) column reservation. Depending on the format of the reservation, power-saving may be possible. Go to Step 420. In this case, FIGS. 7, 8, 9 and 10 (right side) illustrate some examples of possible allocations.

Step 430: From Decision Step 402: If No; or From Decision Step 404: If Full (e.g. >50%) for both: Then No optimization needed.

Step 432: Decision: DRP or PCA?

Step 434: If DRP: Then make a “safe” reservation (if possible) based on Application QoS requirements and Device Profile. Go to Step 420. In this case, FIGS. 5 (right side), 8, 9, 10 (right side), 11 and 12 illustrate some examples of possible allocations.

Step 436: If PCA: (when few neighbors and almost no other reservations/data traffic): Then Start contending for channel access with PCA. If conditions change, run the Resource Allocation Algorithm again (Step 302 of FIG. 3).

### VI. Examples of the Type and Placement of the Reservation

In the following, a few examples are discussed to show the results of various embodiments of the present invention in establishing the type and placement of an access reservation.

Since the current MAS allocation policies do not allow making a “safe” reservation next to a beacon zone, there are some steps described below, which are used to circumvent the problem and enable more power-efficient reservations:

It might be preferable to make an “unsafe” reservation in the beginning (or at the end,) if the superframe usage is not high, and prepare to relocate the reservation to a corresponding “safe” reservation. FIG. 5 is an illustration of an example of this allocation after running the resource allocation algorithm and optimization (described in FIGS. 3 and 4). The “unsafe” reservation can occupy, e.g., the first half (or the second half) of the superframe, but during the second half (or the first half), the devices can sleep, as shown in FIG. 5.

Further, it is possible to divide a DRP reservation so that it logically has an “unsafe part” and a “safe part” (however, the “unsafe” bit covers the whole DRP IE, so if there is even one MAS violating the safeness rules, the whole DRP reservation is “unsafe”): FIG. 6 is an illustration of an example of this allocation after running the resource allocation algorithm and optimization (described in FIGS. 3 and 4). This way, the device can better be prepared to make its “unsafe” reservation “safe” if requested by maintaining the safe part untouched and modify only the “unsafe” part (or release it completely). In FIG. 6, an exemplary reservation of this kind is shown.

Additionally, making of a large reservation in the beginning of the superframe after the beacon zone can also be used in other power-efficient way: if on a superframe the transmitter doesn't have data to send for the duration of the whole reservation, the owner can explicitly release the rest of the reservation (BUT only for that specific superframe) and enter sleep mode.

In principle, the idea is to have one stream for one application. However, since the “safeness” rules are mainly on a per stream basis, it is possible to actually make more than one DRP reservation for an application. According to embodiments of the present invention, it is possible to make “safe” reservations closer to the beacon zone. Also, the device can reserve many more MASs than it actually needs. For example, if the MASs are close to the beacon zone, the device can only use, e.g., the first half (or the second half) of the reservations and then enter sleep mode for the second half (or for the first half) of the reservation. If the device behaves properly, it first releases the unused MASs (BUT, only for the rest of the superframe), so that other devices can also utilize the unused MASs, as shown in FIG. 7. FIG. 7 is an illustration of an example allocation after running the resource allocation algorithm and optimization (described in FIGS. 3 and 4).

When the intended transmitter of the audio/video stream has received the Device Profile of the intended receiver, the transmitter may exploit the information when deciding what kind of reservation needs to be made. In the following, some general guidelines for resource allocation algorithm are given when using Device Profile parameters according to embodiments of the present invention.

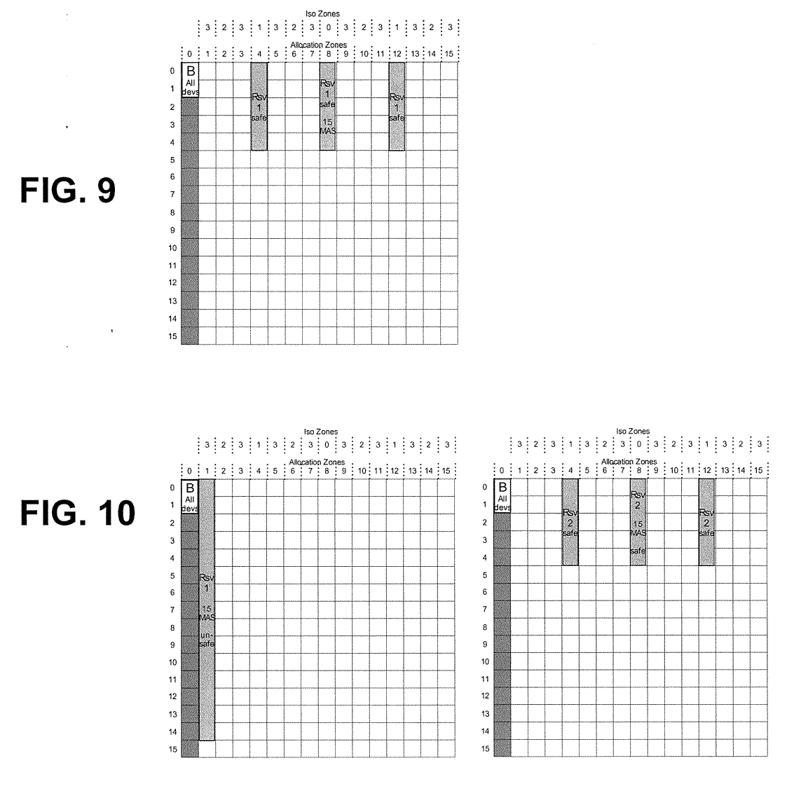

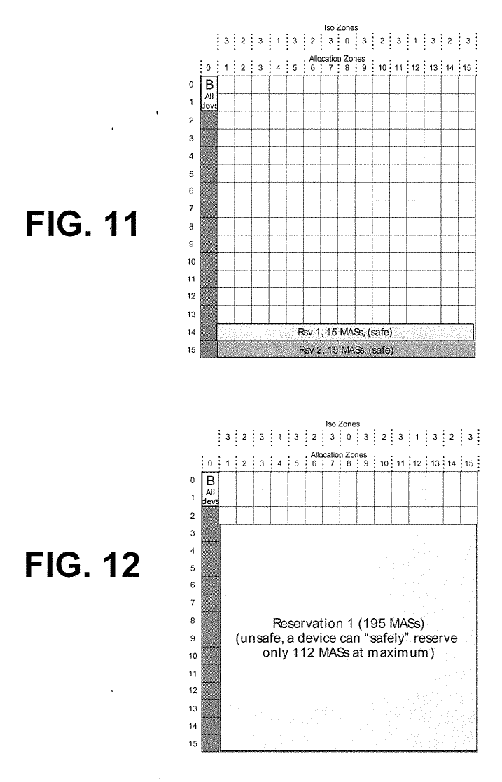

However, the list of used Device Profile parameters is not meant to be complete, as it is only intended to show with some examples what kind of decisions can be made from a given set of Device Profile parameters, according to various embodiments of the present invention.
Compression Support: the type of the codec has impact on the created audio/video bit stream. E.g. DVD-quality MPEG-2 coded video stream varies between 4-10 Mbps (depending on the used resolution).
Constant bit rate codec: for constant bit rate codecs, the resource reservation is fairly straightforward: the required bit rate is known and the number of required MASs can be directly calculated with some reserve MASs. FIG. 8 shows an example reservation for Constant Bit Rate (CBR) video stream. The allocation FIG. 8 is a general example, which results from applying the MAS allocation policy rules defined in the WiMedia MAC specification.
Variable bit rate codec: estimating bandwidth requirement is trickier. However, the resource allocation routine can make some assumptions on the number of required MASs based on statistical, historical or some other data. E.g. for MPEG-2 coded video stream, the allocation routine can reserve MASs such that the reservation can carry the required maximum 10 Mbps even with one bit rate class lower than the target physical layer bit rate (e.g., if the reservation is made for the current radio conditions that allow up to 400 Mbps, the reservation can be made so that also the bit rate of 320 Mbps can provide the capacity of 10 Mbps). FIG. 9 shows an example reservation. The allocation FIG. 9 is a general example, which results from applying the MAS allocation policy rules defined in the WiMedia MAC specification.
Available buffer space: if the receiver has a sufficient amount of buffer space (e.g. to hold all the video data frames for the duration of a superframe), the transmitter may try to reserve a continuous chunk of MASs and then sleep for the rest of the superframe. This way, both the transmitter and the receiver can save some power. However, since the MAC MAS allocation policy forces “safe” reservations to be allocated evenly across the whole superframe (no time for sleep!), it might be preferable to make an “unsafe” reservation in the beginning (if the superframe usage is not high) and prepare to relocate the reservation for a corresponding ” safe” reservation. The “unsafe” reservation can occupy e.g. the first half of the superframe, but during the second half, the devices can sleep, as shown in FIG. 10. FIG. 10 is an illustration of an example allocation after running the resource allocation algorithm and optimization (described in FIGS. 3 and 4).
Power supply (inside Device Info): if both devices are externally powered, the number of reserved MASs and their formation can be more freely decided. Since the receiver cannot know in advance if the transmitter has something to send, e.g. during the next reserved MAS, the receiver needs to have its radio receiver on all the time. However, the transmitter has more control on its radio usage. Thus, the transmitter has to especially take into account the receiver's power supply. If the receiver is battery-powered, the transmitter can try to make as power-efficient MAS allocation as possible (close to next/previous beacon zone).
Real-time vs. non-real-time stream: if the video stream is recorded in advance and it is just “played” over the radio interface, more buffering can be used (if available). This means that on radio interface the data can be sent in bigger, continuous chunks of MASs. Even on some superframes the reservation can be left unused and instead, the devices can sleep. However, if the video stream is real-time (e.g. video conferencing) where the timing is more strict (no delays allowed), this method cannot be applied. In FIG. 11, an example for real-time video transfer with strict timing constraints can be found. The allocation FIG. 11 is a general example, which results from applying the MAS allocation policy rules defined in the WiMedia MAC specification.
Non-compressed audio/video stream: resolution, color depth and frame rate define the total required bit rate. For example, VGA-sized stream with 640×480 pixels, 32 bits of color information per pixel and 30 frames per second produces ˜300 Mbps of video stream payload. In order to transfer this amount of bits over UWB radio interface, not that much room for different variations in MAS allocation remains. FIG. 12 shows an example reservation for this kind of video stream. The allocation FIG. 12 is a general example, which results from applying the MAS allocation policy rules defined in the WiMedia MAC specification.
Double line/frame reception (inside Device info): in some cases—e.g. when the radio conditions are such that there are numerous frame errors, but otherwise lots of radio resources available—it is also possible to over-reserve MASs so that the available “unnecessary” radio resources are actually used to send each video stream frame twice. This kind of simple forward error correction can be employed, if the receiver supports the double line/frame reception. However, from the power-efficiency point of view, this is not the best solution to transmit video stream on a noisy radio channel.
Audio type: if audio channel(s) are transferred together with video stream, it is possible to piggyback audio frames on the same reservation(s) as video stream. However, it is also possible to reserve a separate reservation for audio only, if that meets the specific audio requirements better. After all, the amount audio data is small compared to video data.

### VII. General Architecture of a Transmitter and Receiver

Embodiments of the invention support both non-compressed and compressed video transfer. Non-compressed video transfer includes raw RGB streaming with or without audio stream(s). Embodiments of the invention do not restrict the type of video transfer. The actual video compression and/or signal processing mechanisms are typically managed by the AVI layer.

A. The Transmitter and Receiver

According to various embodiments of the present invention, the wireless protocol can be used in two ways:

1. The wireless protocol both as control and transport protocol, or

2. The wireless protocol only as control protocol

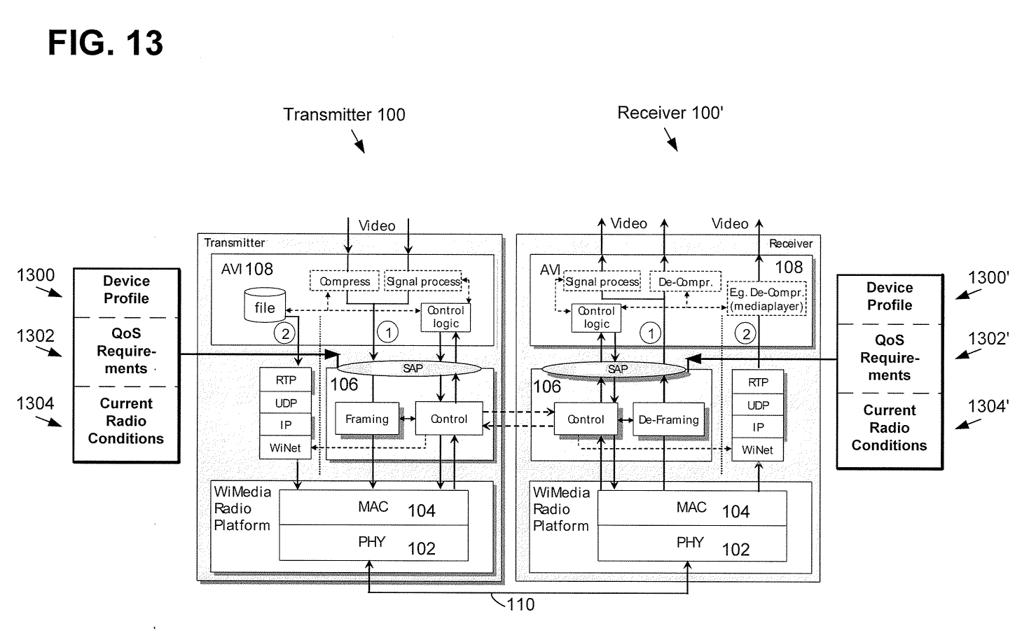

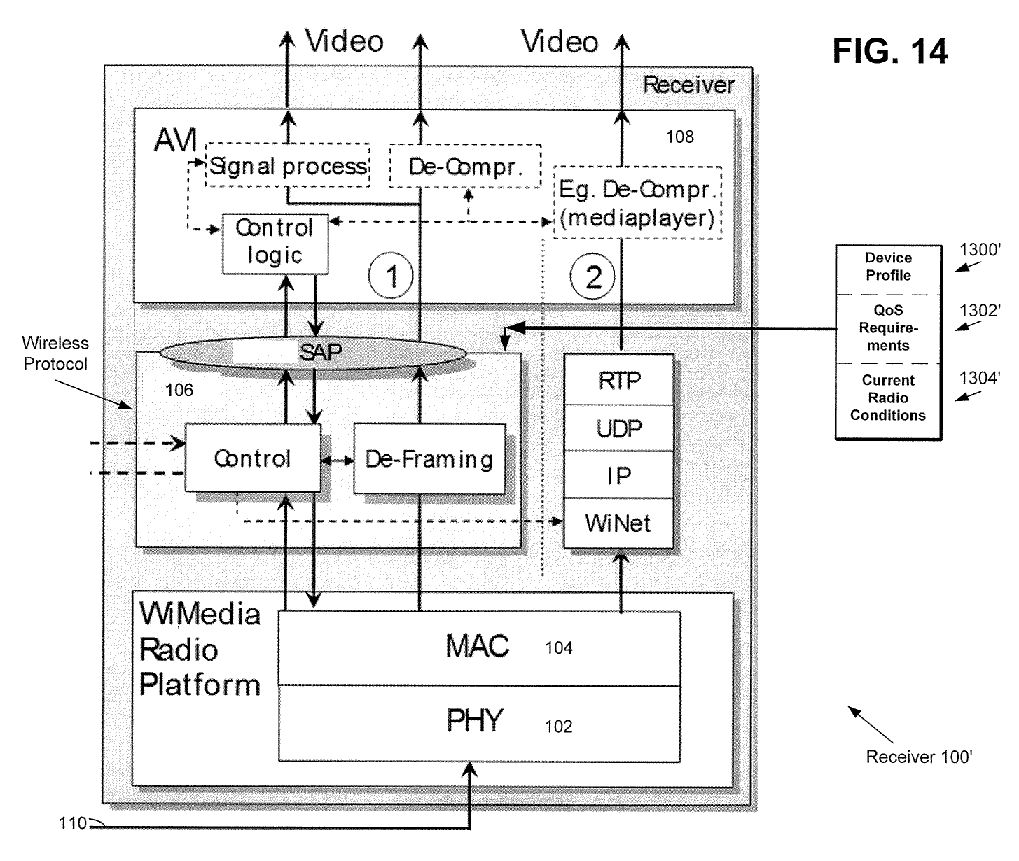

The general architecture of a transmitter and receiver for the two options is slightly different. In FIG. 13, both options are presented. FIG. 14 is a more detailed diagram of the receiver of FIG. 13. FIG. 13 shows the Device Profile module 1300′ for the receiver device 100′ providing profile information characterizing device 100′ to the wireless protocol 106, which will send the profile information to the wireless protocol 106 of the transmitter device 100. Typically, it is the transmitter that knows the QoS requirements for an application. Thus, typically, no QoS parameters/requirements are stored in the receiving device. An exception to this is when there is an application-level negotiation of QoS parameters, the receiver will know the QoS requirements for the negotiated application. Additionally, the device profile of the receiver may contain some parameters (e.g., available buffer space in the receiver) that can be considered to be QoS parameters/requirements. Thus, receiver-side requirements based on preliminary negotiations or receiver characteristics are somewhat similar to QoS requirements at the transmitter-side, which refer to the transmitter-side application's QoS requirements. Such receiver-side requirements can be referred to herein as “Receiver QoS Requirements,” to distinguish them from the transmitter-side QoS requirements. Thus, FIG. 13 shows the Receiver QoS requirements module 1302′ for the receiver device 100′ providing Receiver QoS requirements information for the receiver device 100′ and the application running in device 100′ to the wireless protocol 106, which will, optionally, send the Receiver QoS requirements information to the wireless protocol 106 of the transmitter device 100. FIG. 13 shows the current radio conditions module 1304 of the transmitter device 100 providing current radio conditions information to the wireless protocol 106. Additionally, information on current radio conditions at the receiver can also be sent to the transmitter. The wireless protocol 106 in the transmitter 100 then determines the optimal radio resource allocation for the Video data to be transferred from the transmitter device 100 over the UWB link 110 to the receiver device 100′, taking into account the application Quality of Service (QoS) requirements information (both transmitter-side QoS requirements of the application and Receiver QoS Requirements, where they are applicable), Device Profile information, and the current radio conditions information.

The transmitter 100 and/or the receiver 100′ monitor radio link quality and the transmitter takes corrective actions if the quality deteriorates. It uses the wireless protocol 106 to provide the basic transport layer functionality, when the wireless protocol is used as a transport protocol. The transmitter 100 uses the wireless protocol 106 for framing the audio and/or video data packets to be forwarded to the MAC layer, when the wireless protocol is used as a transport protocol. It uses the wireless protocol 106 to provide timing and synchronization information for video data packets to be transferred over UWB radio interface, when the wireless protocol is used as a transport protocol

FIG. 14 shows the components of the receiver 100′ of FIG. 13 in more detail. Both the transmitter device 100 and the receiver device 100′ have the same types of components in their respective architectures, enabling their roles as a transmitter and a receiver of audiovisual data to be reversed.

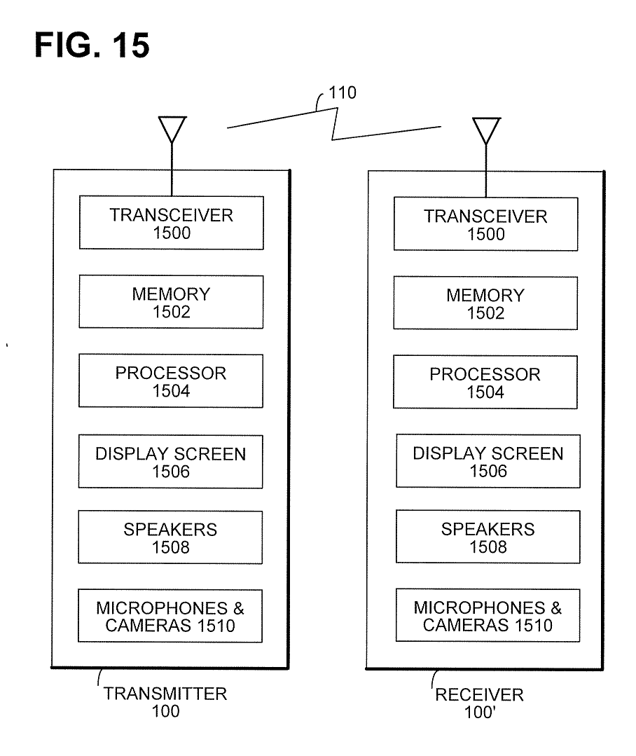

FIG. 15 shows an example hardware implementation of both the transmitter 100 and the receiver 100′. The UWB Radio Channel physical layer 102 in both the transmitter 100 and the receiver 100′ include a transceiver 1500 for communicating with wireless devices across the UWB Radio Channel 110. Both the transmitter 100 and the receiver 100′ include a memory 1502 for storing the program instructions to implement the UWB MAC layer 104, the wireless protocol layer 106, and the Audiovisual Link layer (AVI) 108. The memory 1502 in both the transmitter 100 and the receiver 100′ also stores the Device Profile information, the QoS requirements information, and the current radio conditions information. Both the transmitter 100 and the receiver 100′ include a processor 1504 that respectively executes the instructions stored in the memory 1502 to carry out the various functions described herein. Both the transmitter 100 and the receiver 100′ include a display screen 1506, speakers and/or ear pieces 1508, microphones, digital cameras and video cameras 1510. Other video output devices can include head-mounted displays for virtual reality presentations.

B. The Wireless Protocol

In the following, the two options of the wireless protocol, either including or not including the transport protocol, are described briefly. However, the remainder of this patent describes the option of the wireless protocol used as both control and transport protocol.

### 1. Wireless Protocol as Control and Transport Protocol

When using the wireless protocol for both controlling and transporting of video data, no other transport protocol stack is needed. In FIG. 14, this is represented under the label ‘1’.

Prior to any video transfer, the wireless protocol is used to negotiate the video transfer parameters between the transmitter and receiver. In the wireless protocol, these parameters are defined in the form of device profiles.

The wireless protocol is also taking care of the basic transport layer responsibilities: setting up the video transfer link, controlling the actual video data transfer and tearing down the link after the video feed is finished. Also, the wireless protocol is responsible for creating the audio and video data packets to be delivered to UWB MAC layer. On UWB MAC, the wireless protocol may use a single stream for a video feed: thus, the wireless protocol needs to multiplex audio and video packets from AVI layer into one stream on UWB MAC layer.

When using the wireless protocol as a transport protocol, audio and video signals can come from different sources, or at least from different interfaces. When transferring two distinct signals, e.g., audio and video, over an interface, some entity must take care of synchronization; otherwise achieving, e.g., “lip synch,” is impossible. For synchronization purposes, the wireless protocol provides time stamping mechanism: with a timestamp on every received audio and video packet, the receiver can re-create the original synchronization. However, the actual initial timing has to be provided by a higher layer (for example, AVI layer 108 in FIG. 13) in the transmitting side.

### 2. Wireless Protocol as Control Protocol

If the wireless protocol is used only for controlling purposes, another transport protocol is needed. In FIG. 14, one such an example is shown under the label ‘2’, namely RTP over UDP. Generally, the wireless protocol doesn't restrict the used transport protocol.

When having the wireless protocol as a video transfer control protocol, a reduced set of functionality is needed from the wireless protocol. In this approach, the wireless protocol is only taking care of the initialization and termination of the video transfer. Also, depending on transport protocol stack implementation, the wireless protocol may need to control UWB radio resource allocation by communicating with, e.g., WiNet resource allocation routines. When using WiMedia radio platform and IP-based protocols, the WiMedia Network (WiNET) is required. WiNET is a protocol adaptation layer (PAL) that builds on the WiMedia UWB common radio platform to augment the convergence platform with TCP/IP services.

### VIII. Wireless Protocal Functional Description

The functionality of the wireless protocol is defined as follows. Since the wireless protocol is logically a connection-oriented protocol, the following description is organized according to the basic flow of information exchange, starting from the device discovery to control channel establishment, data transfer and finally connection termination.

A. Discovery

The only discovery mechanism WiMedia radio platform provides is based on broadcast beacons: Each device can insert basic device information into its own beacon and then broadcast it to all neighbors. The wireless protocol also utilizes this mechanism. Each wireless device will include the wireless protocol ASIE (the contents as defined above) into its beacon. When another wireless device receives the beacon containing the wireless protocol ASIE, it can discover and identify the wireless device.

After the initial discovery, wireless devices can ask more detailed device information in the form of wireless device profile.

If the wireless protocol is used together with WiNet, the initial wireless protocol discovery mechanism (with the wireless protocol ASIE) can still be used.

B. Authentication and Security

Preferably, the wireless protocol should use an available authentication mechanism provided by another protocol. For example, WiNet defines an extensive set of features for authentication. If the wireless device does not have any other protocol supporting authentication, the wireless protocol will use the basic set of authentication mechanisms applied, e.g. from WiNet.

If the wireless protocol is used together with WiNet, the WiNet discovery, authentication and association mechanisms will be used.

For encryption, the wireless protocol will use MAC security mechanisms. If a wireless device indicates in its wireless protocol ASIE that it requires encryption, the other wireless devices communicating with the device will use encryption for all the transmitted wireless protocol frames.

C. Wireless Protocol Control Channel

The wireless protocol control channel is a logical channel for transporting the wireless protocol control messages from a wireless device to its peer wireless device(s). The wireless protocol control channel is unidirectional, so both transmitter and receiver will have their own control channels. The wireless protocol control channel can be either dedicated or associated with a video data channel.

The wireless protocol defines altogether four different options for realizing a logical wireless protocol control channel on MAC layer:

1. Using PCA (dedicated control channel): No special reservations are made on radio interface for the control channel. The basic PCA rules are applied when transmitting the control message. In practice, this means that the delivery of the control message may take an arbitrary amount of time. However, using PCA may be more power-efficient than, e.g., having a dedicated DRP reservation, so this method is useful especially for battery-powered devices for non-time-critical control messages. Typically, this kind of wireless protocol control channel is used for establishing the actual video transfer channel or requesting device profiles.

2. Using PCA reservation (dedicated control channel): When the used radio channel starts to be congested, it is preferable to protect some time of each superframe for PCA traffic. PCA reservation can be used for this. PCA reservation does not have an owner, so every device can access the radio medium during the PCA reservation. Normally, it is preferable to make the PCA reservation in the beacon zone: since the devices need to be active anyway for the beacons, it is very power-efficient to also transmit the wireless protocol control messages right after the beacons. This way, all the (battery-powered) wireless devices can switch their radios off for the rest of the superframe. Another power-efficiency benefit for PCA reservation is that no DRP reservations can be placed on beacon zone; thus, no DRP reservation can be as power-efficient as PCA reservation placed on beacon zone.

3. Using DRP reservation (dedicated control channel): For the devices having no issues with power supply, DRP reservation is the best choice for the control channel. Since the amount of transmitted wireless protocol control messages per one superframe is fairly low, only few MASs is required for the wireless protocol control channel DRP reservation. All the DRP reservation has to follow the MAS allocation policies defined in MAC specification, so probably the wireless protocol control channel DRP reservations will end up somewhere in the middle of the superframe, as far as possible from the time-wise closest beacon zone. This means that DRP reservations are not the choice for battery-powered wireless device, unless the wireless protocol control channel is used only for a restricted period of time.

4. Using DRP reservation of the actual video data transfer (associated control channel): for each video stream, the wireless protocol will make a separate DRP reservation. Since the bandwidth and delay requirements are fairly strict for video transfer, the wireless protocol needs to reserve some extra MASs for DRP reservations for video transfer. However, the amount of possible control messages per each superframe during video transfer is so low that the wireless protocol control messages can easily be transported using the same reservation. However, this option is only available for the transmitter.

When establishing or modifying a wireless protocol Control Channel realized with option 2, 3 or 4, the originator of the control channel will inform its peer device(s) about the change and the exact new MASs with CONTROL CHANNEL INDICATION message.

For the wireless protocol on the receiving side, it does not make any difference what above described option was used for the wireless protocol control messages, since each wireless protocol control message can be identified from the header. Thus, a transmitting device may establish first a dedicated control channel and later “merge” it with the actual data transfer channel (i.e. DRP reservation).

The wireless protocol can transmit a wireless protocol error message to its peer device(s) anytime. However, it doesn't matter what kind of control channel is used.

D. Device Profile

The wireless protocol uses device profiles to characterize each device's capabilities. Before any video transfer can be made, the transmitter will request the device profile of the intended receiver by sending DEVICE PROFILE REQUEST message. The intended receiver will reply with DEVICE PROFILE RESPONSE message containing the device profile data.

The transmitter can exploit the device profile information obtained from the receiver when deciding what kind of reservation would be needed for the video feed. In addition to that, the transmitter can check, prior to the actual DRP establishment, whether there are enough resources for the intended video transfer.

E. Initialization

Before the actual video data transfer, a dedicated connection—with WiMedia MAC, a DRP reservation—has to be established. After a trigger from higher layer (e.g. AVI), the wireless protocol in the transmitter sends a request, STREAM REQUEST message, to the intended receiver. The message contains the proposed parameters for the video transfer. The receiver can accept the parameters (or optionally define a new set of parameters) and confirm the new stream by STREAM RESPONSE message.

After receiving the response from the intended receiver, the transmitter can start establishing a DRP reservation for the video stream. Depending on the video stream quality of service (QoS) requirements, either a “row” reservation (MAC terminology) or a smaller ” column” reservation is established. Due to high bandwidth requirements for video transfer, it is likely that UWB radios will be on for the whole superframe for the duration of the video stream. For battery-powered devices this means a high level of power consumption.

After a successful reservation establishment, the wireless protocol layer informs the receiver about the starting of the video stream by sending a PLAY message.

F. Data Transfer

After successfully establishing a DRP reservation for the video feed, the actual video transfer can start. During the initialization, the transmitter and receiver agree what is to be the format of the AV stream. For example, using a raw RGB image as a payload, it is normally agreed that a single line of a video frame is transmitted in a wireless protocol video data packet.

The wireless protocol assumes that the upper layer (e.g. AVI) is taking care of audio and data packetization. The wireless protocol may provide separate channels for audio and video. However, it is the responsibility of AVI layer to regenerate the synchronization of audio and/or video streams.

The maximum packet size the wireless protocol supports is 32 000 bytes. The MAC layer may fragment the data frames that the wireless protocol forwards to it (or aggregate small packets together). The wireless protocol layer encapsulates the AV data packets from upper layers, adds header information (timestamp, sequence number) and forwards the packets to the MAC layer.

The wireless protocol should have fast access to radio medium thanks to the dedicated DRP reservation. However, a reasonable amount of buffering space is required, especially at the receiving side (at least on radio layers) for reconstructing the fragmented AV data packets before delivering them to upper layers. The actual buffer dimensioning is left for the device's actual implementation.

To adjust to the changing radio conditions, the wireless protocol provides a link feedback mechanism. Periodically during the video feed, the receiver may send a LINK FEEDBACK message to the transmitter. With this information, the transmitter may, e.g., modify the DRP reservation to better reflect the current radio conditions.

The wireless protocol may also use other means to make the most out of UWB radio channel: For example, if there is excessive bandwidth available, but the link quality is marginal, the wireless protocol may, e.g., send each video data packet twice (if the receiver supports double line reception for video). Of course, other effective forward error correction or other link utilization improvement mechanisms may be applied.

G. Suspending and Resuming Video Feed

Since having UWB radios on all the time is fairly power-consuming, it is preferable to release radio resources if they are not currently used. For this, the wireless protocol provides a suspending and resuming mechanism. When the transmitter notices (or is informed) that there will be a break, which is considerably longer than a single superframe(˜65 ms), the transmitter can release the DRP reservation and inform the receiver with a PAUSE message. When the video feed is resumed, the transmitter needs to re-establish the necessary reservations. When that is successfully completed, the transmitter sends a PLAY message to the receiver to indicate the resuming of the video feed.

H. Closing the Connection

When the video stream has been terminated, the associated resources need to be released. The wireless protocol on the transmitter side informs the receiver about the termination with a TERMINATE message. Immediately after sending the message, the transmitter releases the DRP reservation allocated for the video stream. Also, both transmitter and receiver need to release the control channels associated with the video stream.

Optionally, also the receiver can request the termination of the video stream. For this purpose, the wireless protocol defines DISCONNECT REQUEST message. When the video feed transmitter receives the message, it will initiate the termination procedure.

I. Using MAC Services

In order to make the wireless protocol work efficiently, the wireless protocol implementation has to have a fairly high level of control of MAC layer features. For example, without effectively dictating the format of a DRP reservation, the wireless protocol cannot make the best reservation for a video stream. To distinguish different MAC service users on MAC level, a specific MAC Multiplex (MUX) header is used.

### IX. Conclusion

While various embodiments of the present invention have been described above, it should be understood that they have been presented by way of example only, and not in limitation. For instance, the features described herein may be employed in networks other than WiMedia networks.

Accordingly, it will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method in a wireless communications device, the method comprising:
storing device profile information, the device profile information describing characteristics of the wireless device's audiovisual reception capabilities and output capabilities;
receiving a request for said device profile information from a peer wireless device;
sending said device profile information to said peer wireless device, as a preliminary step to receiving audiovisual data from said peer device; and
receiving reservation information from said peer wireless device in response to said device profile information for reserving a portion of available communication bandwidth to receive said audiovisual data from said peer wireless device.

2. The method of claim 1, which further comprises:
said reservation information being further in response to QoS requirement information describing QoS parameters for an audiovisual application.

3. The method of claim 2, which further comprises:
said reservation information being further in response to current radio conditions, including reservations by other wireless devices of available communication bandwidth.

4. The method of claim 1, which further comprises:
said device profile information including power supply status information;
said reservation information establishing an optimal radio resource allocation to minimize power consumption in response to said power supply status information.

5. The method of claim 1, which further comprises:
said reservation information reserving a portion of available media access slots (MAS) of a WiMedia Ultra Wide Band (UWB) link to ensure safe data transfer, while taking into account possible power saving requirements for receiving said audiovisual data.

6. The method of claim 1, which further comprises:
receiving control information from said peer wireless device releasing radio resources when they are not needed.

7. The method of claim 1, which further comprises:
said reservation information reserving a portion of available media access slots (MAS) of a WiMedia Ultra Wide Band (UWB) link, taking into account application QoS parameters and current radio conditions, as well as said Device Profile information.

8. A method in a wireless communications device, the method comprising:
sending a request for device profile information to a receiving wireless device, the device profile information describing characteristics of the receiving wireless device's audiovisual reception capabilities and output capabilities;
receiving said device profile information, as a preliminary step to sending audiovisual data to said receiving device; and
sending reservation information in response to said device profile information for reserving a portion of available communication bandwidth to send said audiovisual data to said receiving wireless device.

9. The method of claim 8, which further comprises:
said reservation information being further in response to QoS requirement information describing QoS parameters for an audiovisual application.

10. The method of claim 9, which further comprises:
said reservation information being further in response to current radio conditions, including reservations by other wireless devices of available communication bandwidth.

11. The method of claim 8, which further comprises:
said device profile information including power supply status information for said receiving wireless device;
said reservation information establishing an optimal radio resource allocation to minimize power consumption in response to said power supply status information.

12. The method of claim 8, which further comprises:
said reservation information reserving a portion of available media access slots (MAS) of a WiMedia Ultra Wide Band (UWB) link to ensure safe data transfer, while taking into account possible power saving requirements for sending said audiovisual data.

13. The method of claim 8, which further comprises:
sending control information to said receiving wireless device releasing radio resources of said receiving wireless device when they are not needed.

14. The method of claim 8, which further comprises:
said reservation information reserving a portion of available media access slots (MAS) of a WiMedia Ultra Wide Band (UWB) link, taking into account application QoS parameters and current radio conditions, as well as said Device Profile information.

15. The method of claim 8, which further comprises:
before said step of sending reservation information, calculating said reservation information based on said received device profile information to reserve said portion of available communication bandwidth to enable sending said audiovisual data to said receiving wireless device.

16. A wireless communications device, comprising:
a transceiver for communicating with devices across a wireless communications network;
a memory;
a processor that executes instructions stored in the memory for:
storing device profile information in the memory, describing characteristics of the wireless device's audiovisual reception capabilities and output capabilities;
receiving a request via said transceiver for said device profile information from a peer wireless device;
sending via said transceiver said device profile information to said peer wireless device, as a preliminary step to receiving audiovisual data from said peer device; and
receiving via said transceiver reservation information from said peer wireless device in response to said device profile information, reserving of a portion of available communication bandwidth to receive said audiovisual data.

17. The device of claim 16, which further comprises:
said reservation information being further in response to QoS requirement information describing QoS parameters for an audiovisual application.

18. The device of claim 17, which further comprises:
said reservation information being further in response to current radio conditions, including reservations by other wireless devices of available communication bandwidth.

19. The device of claim 16, which further comprises:
said device profile information including power supply status information for said wireless device;
said reservation information establishing an optimal radio resource allocation to minimize power consumption by said wireless device in response to said power supply status information.

20. The device of claim 16, which further comprises:
said reservation information reserving a portion of available media access slots (MAS) of a WiMedia Ultra Wide Band (UWB) link to ensure safe data transfer, while taking into account possible power saving requirements for receiving said audiovisual data.

21. The device of claim 16, which further comprises:
said processor further executing instructions stored in the memory for:
receiving control information from said peer wireless device releasing radio resources of said wireless device when they are not needed.

22. The device of claim 16, which further comprises:
said reservation information reserving a portion of available media access slots (MAS) of a WiMedia Ultra Wide Band (UWB) link, taking into account application QoS parameters and current radio conditions, as well as said Device Profile information.

23. A wireless communications device, comprising:
a transceiver for communicating with devices across a wireless communications network;
a memory;
a processor that executes instructions stored in the memory for:
sending via said transceiver a request for device profile information from a receiving wireless device, the device profile information describing characteristics of the receiving wireless device's audiovisual reception capabilities and output capabilities;
receiving via said transceiver said device profile information, as a preliminary step to sending audiovisual data to said receiving device; and
sending via said transceiver reservation information in response to said device profile information, reserving of a portion of available communication bandwidth to send said audiovisual data.

24. The device of claim 23, which further comprises:
said reservation information being further in response to QoS requirement information describing QoS parameters for an audiovisual application.

25. The device of claim 24, which further comprises:
said reservation information being further in response to current radio conditions, including reservations by other wireless devices of available communication bandwidth.

26. The device of claim 23, which further comprises:
said device profile information including power supply status information for said receiving wireless device;
said reservation information establishing an optimal radio resource allocation to minimize power consumption by said receiving wireless device in response to said power supply status information.

27. The device of claim 23, which further comprises:
said reservation information reserving a portion of available media access slots (MAS) of a WiMedia Ultra Wide Band (UWB) link to ensure safe data transfer, while taking into account possible power saving requirements for sending said audiovisual data.

28. The device of claim 23, which further comprises:
said processor further executing instructions stored in the memory for:
sending with said transmitting wireless device control information to said receiving wireless device releasing radio resources of said receiving wireless device when they are not needed.

29. The device of claim 23, which further comprises:
said reservation information reserving a portion of available media access slots (MAS) of a WiMedia Ultra Wide Band (UWB) link, taking into account application QoS parameters and current radio conditions, as well as said Device Profile information.

30. The device of claim 23, which further comprises:
said processor further executing instructions stored in the memory for:
before said step of sending reservation information, calculating said reservation information using said device profile information to reserve said portion of available communication bandwidth to enable sending said audiovisual data to said receiving wireless device.

31. An apparatus, comprising:
means for storing device profile information in a wireless device, describing characteristics of the wireless device's audiovisual reception capabilities and output capabilities;
means for receiving a request for said device profile information from a peer wireless device;
means for sending said device profile information to said peer wireless device, as a preliminary step to receiving audiovisual data from said peer device; and
means for receiving reservation information from said peer wireless device in response to said device profile information, reserving of a portion of available communication bandwidth to receive said audiovisual data.

32. An apparatus, comprising:
means for sending with a transmitting wireless device a request for device profile information from a receiving wireless device, the device profile information describing characteristics of the receiving wireless device's audiovisual reception capabilities and output capabilities;
means for receiving at said transmitting wireless device said device profile information, as a preliminary step to sending audiovisual data to said receiving device; and
means for sending with said transmitting wireless device reservation information in response to said device profile information, reserving of a portion of available communication bandwidth to send said audiovisual data.

33. The apparatus of claim 32, which further comprises:
means for calculating said reservation information using said device profile information to reserve said portion of available communication bandwidth to enable sending said audiovisual data to said receiving wireless device.

34. A computer program product, comprising:
a computer readable medium having computer program code therein;
program code in said computer readable medium, for storing device profile information in a wireless device, describing characteristics of the wireless device's audiovisual reception capabilities and output capabilities;
program code in said computer readable medium, for receiving a request for said device profile information from a peer wireless device;
program code in said computer readable medium, for sending said device profile information to said peer wireless device, as a preliminary step to receiving audiovisual data from said peer device; and
program code in said computer readable medium, for receiving reservation information from said peer wireless device in response to said device profile information, reserving of a portion of available communication bandwidth to receive said audiovisual data.

35. The computer program product of claim 34, which further comprises:
said reservation information being further in response to QoS requirement information describing QoS parameters for an audiovisual application.

36. The computer program product of claim 34, which further comprises:
said reservation information being further in response to current radio conditions, including reservations by other wireless devices of available communication bandwidth.

37. A computer program product, comprising:
a computer readable medium having computer program code therein;
program code in said computer readable medium, for sending with a transmitting wireless device a request for device profile information from a receiving wireless device, the device profile information describing characteristics of the receiving wireless device's audiovisual reception capabilities and output capabilities;
program code in said computer readable medium, for receiving at said transmitting wireless device said device profile information, as a preliminary step to sending audiovisual data to said receiving device; and
program code in said computer readable medium, for sending with said transmitting wireless device reservation information in response to said device profile information, reserving of a portion of available communication bandwidth to send said audiovisual data.

38. The computer program product of claim 37, which further comprises:
said reservation information being further in response to QoS requirement information describing QoS parameters for an audiovisual application.

39. The computer program product of claim 37, which further comprises:
said reservation information being further in response to current radio conditions, including reservations by other wireless devices of available communication bandwidth.

40. The computer program product of claim 37, which further comprises:
program code in said computer readable medium, for calculating said reservation information using said device profile information to reserve said portion of available communication bandwidth to enable sending said audiovisual data to said receiving wireless device.

41. A wireless communications system, comprising:
a wireless receiver in a network, for storing device profile information describing characteristics of the receiver's audiovisual reception capabilities and output capabilities;
a wireless transmitter in the network, for sending a request to said receiver for said device profile information, as a preliminary step to sending audio/visual data to said receiver;
said transmitter receiving said device profile information and, in response, sending to said receiver reservation information reserving of a portion of available communication bandwidth to send said audiovisual data to said receiver.

42. The system of claim 41, which further comprises:
said transmitter calculating said reservation information using said device profile information to reserve said portion of available communication bandwidth to enable sending said audiovisual data to said receiving wireless device.

43. A method in a wireless communications network, the method comprising:
storing device profile information in a wireless receiver device in the network, the device profile information describing characteristics of the wireless receiver device's audiovisual reception capabilities and output capabilities;
sending by a wireless transmitter device in the network to said wireless receiver device, a request for said device profile information;
sending by said wireless receiver device, said device profile information to said wireless transmitter device, in response to said request; and
sending by said wireless transmitter device, reservation information in response to said device profile information, for reserving a portion of available communication bandwidth to send said audiovisual data to said wireless receiver device.

44. The method of claim 43, which further comprises:
before said step of sending reservation information, said wireless transmitter device calculating said reservation information using said device profile information to reserve said portion of available communication bandwidth to enable sending said audiovisual data to said receiver wireless device.
